(19) United States
(12) Patent Application Publication
(10) Pub. No.: US 2008/0019782 A1
(43) Pub. Date: Jan. 24, 2008

(54) Vibration body for cutting, vibration cutting unit, processing apparatus, molding die, and optical element

(75) Inventors: Toshiyuki Imai, Tokyo (JP); Shigeru Hosoe, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/826,801

(22) Filed: Jul. 18, 2007

(30) Foreign Application Priority Data
Jul. 21, 2006 (JP) JP2006-200115

(51) Int. Cl. B26D 1/00

(52) U.S. Cl. 407/11; 385/147; 407/104; 65/361

(57) ABSTRACT

The tensile strength of the first fixing member is larger than the tensile strength of the second fixing member. When the attaching and detaching of the cutting tool is repeated, although the second fixing member having a smaller tensile strength gets deteriorated, it is sufficient to replace the second fixing member, and it is possible to prevent breakage of the first fixing member, and it is possible to reduce the frequency of replacing the vibration body. As the material for first fixing member, it is possible to use high-speed steel, cemented carbide, SCM steel (chrome molybdenum steel), etc. As the material for the second fixing member, it is possible to use cemented carbide, SCM steel, etc.

This application is based on Japanese Patent Application No. 2006-200115 filed on Jul. 21, 2006 in Japanese Patent Office, the entire content of which is hereby incorporated by reference.

### BACKGROUND OF THE INVENTION

The present invention relates to a vibration body for cutting, a vibration cutting unit and a processing device used favorably in the case of forming a molding die for an optical element and others, and a molding die and an optical element produced by using the aforesaid devices.

There is available a technology to cut materials such as carbide and glass which are hard-to-cut materials by vibrating a tip of a cutting tool such as a diamond tool, which is called vibration cutting. In this technology, minute cutting-in is conducted at high speed by a cutting edge of a cutting tool through vibration, and chips generated in this time are scraped out by the cutting edge through vibration, resulting in realization of cutting processes which cause less stress for a cutting tool and a material to be cut (for example, see Patent Documents 1, 2, 3 and 4). Owing to this process of vibration cutting, a critical depth of cut needed for an ordinary cutting of ductile mode is improved to be several times as large as its normal depth, thus, the hard-to-cut materials can be subjected to cutting process at high efficiency.

In such process of vibration cutting of this kind, high speed vibration of 20 kHz or more is usually used, because for improving the efficiency of processing, when a vibration frequency is enhanced, the aforesaid effects are increased and a feed rate for the tool is also enhanced in proportion substantially to the frequency. There is also an advantage that an oscillator or a vibration body excited by the oscillator does not cause an offensive noise, because the aforesaid frequency is beyond a human audible range.

As a method to generate high speed vibration on a cutting edge of a cutting tool, a method has been put to practical use wherein a holding member that holds a tool is excited with a piezoelectric element or a super-magnetostrictor, to vibrate stably as a standing wave, by resonating this holding member with bending vibration and axial vibration (axial direction vibration). For such a method, the cutting tool is fixed removably to the tip of the holding member which is a vibration body on the base side.

Although generally chrome-molybdenum steel is used as the above holding member, there are cases in which the friction is generated between the cutting tool and the holding member during vibration cutting, resulting in generating heat, and in such cases, because of that heat the oscillator expands and causes the position of the tool tip to vary, thereby causing the problem that high accuracy machining cannot be made. Therefore, it is possible to think of using, for example, a high hardness ceramic material with a low coefficient of linear expansion such as silicon nitride, or an alloy material with a low coefficient of linear expansion. However, when an attempt is made to provide a tread portion that is normally provided for fixing the cutting tool, in a holding member made of such a material, there were the problem that it was either not possible to form the threads because of cracking or breakage of the holding member, and even if the thread portion could be formed, it was not possible to fix the cutting tool to the holding member sufficiently strongly. Or else, due to the frequent removal and attachment of the cutting tool to the holding member, the thread portion got deformed or broken and it was not possible to fix the cutting tool to the holding member with sufficient strength, or the holding member itself had to be replaced.

In view of this, a purpose of the present invention is to provide a vibration body for cutting in which the fasteners such as nuts, etc., are resistant to breakage even when the attaching and detaching of the cutting tool is repeated, and that can easily maintain strong fixing of the cutting tool, and to provide a vibration cutting unit incorporated with such a vibration body for cutting.

Further, another purpose of the present invention is to provide molding dies and optical elements that are manufactured with high precision using the above vibration cutting unit.

Patent Document 1: Japanese Unexamined Patent Application Publication No. 2000-52101

Patent Document 2: Japanese Unexamined Patent Application Publication No. 2000-218401

Patent Document 3: Japanese Unexamined Patent Application Publication No. Hei 9-309001

Patent Document 4: Japanese Unexamined Patent Application Publication No. 2002-126901

### SUMMARY

In order to solve the above problem, the vibration body for cutting according to the present invention has a supporting portion that supports the cutting tool, and transmits the applied vibrations to the cutting tool, the supporting portion fixes the cutting tool in a removable manner due to a first fixing member fixed on the supporting portion and a second fixing member, wherein said first fixing member has a larger tensile strength than the second fixing member.

The vibration cutting unit according to the present invention is provided with (a) a vibration body for cutting described above, and (b) a cutting tool supported by the vibration body for cutting.

The processing apparatus according to the present invention is provided with (a) the vibration cutting unit described above, and (b) a drive unit that displaces the vibration cutting unit by driving the drive unit.

The molding die relating to the present invention has a transfer optical surface for forming an optical surface of the optical element, which is processed and created using the aforementioned vibration cutting unit. In this case, molding dies having a concavity and other various types of transfer optical surfaces can be processed efficiently with high precision.

The optical element relating to the present invention is processed and created using the aforementioned vibration cutting unit. In this case, a highly precise optical element having a convexity and other various types of optical surfaces can be obtained.

### BRIEF DESCRIPTION OF THE DRAWINGS

FIG. 1 is a block diagram for describing the vibration cutting unit according to a first preferred embodiment.

FIGS. 2(a), 2(b), 2(c), and 2(d) are the plan view, end surface view, and side view diagrams of the tip of the tool part.

FIG. 3(a) is a partially enlarged cross-sectional view diagram for describing the condition of the tip part of the tool part, and FIG. 3(b) is an enlarged side view diagram of the cutting tool.

FIG. 4 is a block diagram for describing the processing apparatus of a second preferred embodiment.

FIG. 5 is an enlarged plan view diagram for describing the machining of a work using the processing apparatus shown in FIG. 4.

FIGS. 6(a) and 6(b) are side cross-sectional view diagrams of the molding dies according to a third preferred embodiment.

FIG. 7 is a side cross-sectional view diagram of a lens formed using the molding dies of FIG. 6.

FIG. 8 is a partially enlarged cross-sectional view diagram of the vibration cutting unit of the third preferred embodiment in which the vibration cutting unit shown in FIG. 3 has been modified.

### DETAILED DESCRIPTION OF THE PREFERRED EMBODIMENT

In the above vibration body for cutting, since the first fixing member which is one of the members for fixing the cutting tool in a removable manner has a larger tensile strength than the other second fixing member, it is possible to attach or detach repeatedly the cutting tool without deteriorating or breaking the first fixing member. The first fixing member has preferably larger tensile strength than 1.2 times the tensile strength of the second fixing member and more preferably larger tensile strength than 2.5 times the tensile strength of the second fixing member. At this time, the second fixing member having a relatively smaller tensile strength will have some deformation of the thread portion because of tightening with a force necessary for strongly fixing the cutting tool. Therefore, when the attaching and detaching of the cutting tool is repeated, although there is the possibility of the tread portion of the second fixing member breaking eventually, the deterioration or breaking of the first fixing member, which is a fixed fixing member, is prevented owing to the second fixing member. Therefore, even if the attaching and detaching of the cutting tool to the vibration body for cutting is repeated, it becomes difficult for the first fixing member such as a nut, etc., and the supporting portion to break, and hence it is possible to extend the durability and life of the vibration body for cutting.

Further, in a concrete embodiment of the present invention, in the above vibration body for cutting, the first fixing member is a nut, and the second fixing member is a bolt that screws into the nut. In this case, it is possible to prevent the shearing of the ridges of the threads in the nut and to extend the life of the nut. Although the ridges of the threads of the bolt that is screwed into the nut are likely to be sheared progressively, it is possible to cope with this by merely replacing the bolt.

In another embodiment of the present invention, the bolt is passed through a hole for fixing provided in the cutting tool, and the cutting tool is fixed by being gripped between the supporting surface of the supporting portion and the head of the bolt. In this case, even if the tensile strengths of both the supporting portion and the second fixing member are small, it is possible to fix the cutting tool firmly between these two.

In another embodiment of the present invention, the nut is fixed to the supporting portion. In this case, it is difficult for friction heat caused from high speed vibration between the nut and the supporting portion to be generated. Further, since a nut with a relatively long life is fixed by the supporting portion, it is possible to extend the life of the vibration body for cutting.

In another embodiment of the present invention, the nut has been affixed to the supporting portion by brazing. In this case, the nut can be firmly fixed to the supporting portion in a stable manner.

In another embodiment of the present invention, the vibration body for cutting is formed of a low linear expansion coefficient material. In this case, since it is possible to reduce greatly the expansion of the body part including the supporting portion for the cutting tool, the displacement of the tip of the cutting tool can be reduced and the accuracy of the cutting can be increased. Here, “a low linear expansion coefficient material” means a material with a coefficient of linear expansion from −2×10⁻⁶ to 2×10⁻⁶ (also referred to as a material of a low linear expansion coefficient). Inver, super-Inver, stainless Inver, etc., are used as the low linear expansion coefficient material.

In another embodiment of the present invention, the first fixing member is formed of at least one material in a group that includes high-speed tool steel, cemented carbide, martensitic stainless steel, precipitation hardened stainless steel, and SCM steel. In this case, it is easily possible to make the tensile strength higher compared to the second fixing member, and the machinability of the thread can be secured.

As the second fixing material according to the present invention, it is possible to use various types of metallic materials including various types of stainless steels, or alloys such as SCM steel, etc. In this case, it is easily possible to make the tensile strength lower compared to the first fixing member, and the machinability of the thread can be secured.

In another embodiment of the present invention, the tensile strength of the first fixing member is from 900 N/mm² to 3000 N/mm², and the tensile strength of the second fixing member is from 700 N/mm² to 1900 N/mm². By satisfying this relationship, firm fixing of the cutting tool to the vibration body for cutting can be more securely realized while preventing breakage of the first fixing member or of the supporting portion.

Further, in another embodiment of the present invention, in the above vibration body for cutting, the first fixing member is a bolt, and the second fixing member is a nut that is screwed into by the bolt. In this case, it is possible to prevent the shearing of the ridges of the threads in the bolt and to extend the life of the bolt. Although the ridges of the threads of the nut that is screwed into by the bolt are likely to be sheared progressively, it is possible to cope with this by merely replacing the nut.

In the above vibration cutting unit, since the first fixing member has a larger tensile strength than the second fixing member, it is possible to repeat the attaching and detaching of the cutting tool without deteriorating or breaking the first fixing member, and even if the attaching and detaching of the cutting tool to the vibration body for cutting is repeated, it becomes difficult for the first fixing member such as a nut, etc., and the supporting portion to break, and hence the durability and life of the vibration body for cutting can be extended.

In a concrete embodiment of the above vibration cutting unit, a vibration source is further provided which vibrates the cutting tool via the vibration body for cutting by applying vibrations to the vibration body for cutting. In this case, since the vibration body for cutting, the cutting tool, and the vibration source for them are made into a single unit, it is possible to operate the vibration cutting unit with a high accuracy while enhancing the convenience of assembling and detaching of the vibration cutting unit.

In the aforesaid processing apparatus, highly accurate processing can be realized by the vibration cutting unit having a high durability, because the vibration cutting unit described above is displaced by the driving device.

### First Embodiment

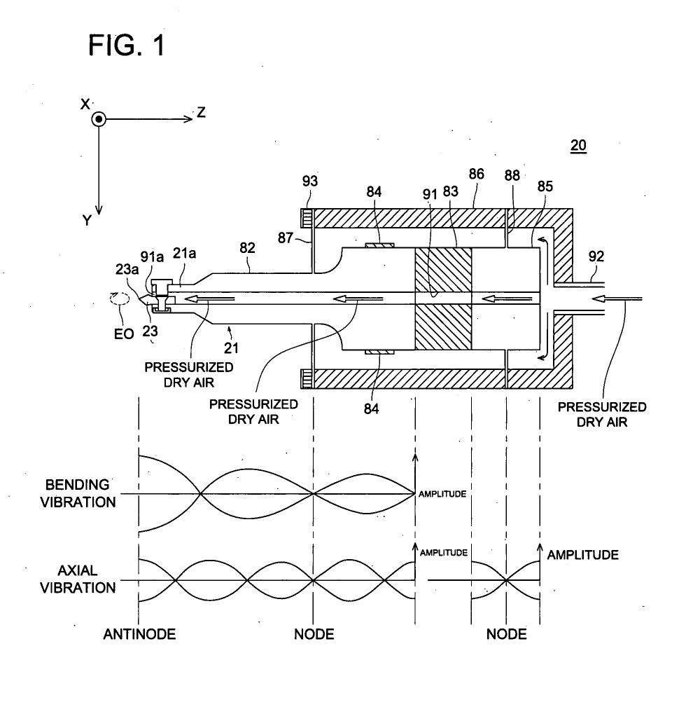

In the following, a vibration body for cutting and a vibration cutting unit according to a preferred embodiment of the present invention are described while referring to the drawings. FIG. 1 is a cross-sectional diagram for describing the structure of the vibration cutting unit that is used for machining the transfer optical surface of the molding dies used for molding optical elements such as lenses, etc.

As shown in FIG. 1, vibration cutting unit 20 is provided with cutting tool 23, vibration body 82, axial direction oscillator 83, bending oscillator 84, counterbalance 85 and with casing 86.

In this case, cutting tool 23 is embedded in to be fixed to portion 21a provided on the tip of tool portion 21 representing the tip side of vibration body 82: Cutting tool 23 whose tip 23a is serving as a cutting edge of diamond tip as described later, vibrates together with the tip of vibration body 82, namely, with fixing portion 21a as an open end of the vibration body 82 that is made to be in the state of resonance. In other words, the cutting tool 23 generates vibrations causing displacement in the Z direction, following vibrations in the axial direction of vibration body 82, and generates vibrations causing displacement in the Y direction, following the bending vibration of vibration body 82. As a result, tip 23a of cutting tool 23 is displaced at high speed, drawing elliptical orbit EO which is illustrated exaggeratedly.

The vibration body 82 is a vibration body for cutting formed integrally using a material having an absolute value of the coefficient of linear expansion of 2×10⁻⁶ or less, and in specific terms, Inver, super-Inver, stainless Inver, etc., are used preferably. The external diameter of the tool part 21 on the tip side of the vibration body 82 is narrow, and the external diameter on the base side is wide. At a suitable location on the side surface of the vibration body 82, a first fixing flange 87 that is a plate shaped part is formed, and the vibration body 82 has been fixed to the casing 86 using for example a screw 93 via the first fixing flange 87. The vibration body 82 vibrates due to the axial direction oscillator 83, and goes into the resonant state in which a standing wave is formed locally in the Z direction. In addition, the vibration body 82 is also vibrated by a bending oscillator 84, and goes into the resonant state in which a standing wave is formed locally in the Y direction. Here, the position of the first fixing flange 87 has become a common node for the axial vibrations and the bending vibrations, and by fixing the vibration body 82 via the first fixing flange 87, it is possible to prevent the axial vibrations and the bending vibrations from being obstructed.

Further, the first fixing flange 87, for example, can be made into a circular plate shaped, fixing member, and in this case, its external circumference part is fixed to the casing 86 and seals the casing 86, and has a structure that has no air passage. The first fixing flange 87 can also be made into a fixing member that has a plurality of openings, and can be made, for example into a fixing member that has thin and long supporting members that extend in three directions. In this case, even if the first fixing flange 87 is fixed to the casing 86, sufficient air passage between the inside and outside of the casing 86 can be obtained.

Axial direction oscillator 83 is a vibration source which is formed by piezoelectric element (PZT) or super-magnetostrictor, and is connected to the end surface on the base side of vibration body 82, and it is connected to an oscillator driving device (to be described later) through unillustrated connectors or the like. The axial direction oscillator 83 gives longitudinal waves to the vibration body 82 by acting based on drive signals coming from the oscillator driving device and by conducting expansion and contraction vibration at high frequency. The axial direction oscillator 83 is displaceable in the direction Z, however not displaceable either in X and Y directions.

Bending oscillator 84 is a vibration source which is formed by piezoelectric element and super-magnetostrictor, and is connected to the side surface on the base side of vibration body for cutting 82, and it is connected to an oscillator driving device (to be described later) through unillustrated connectors or the like. The bending oscillator 84 operates based on drive signals coming from the oscillator driving device, and gives transverse waves, namely, bending vibrations in the Y direction in the illustrated example to the vibration body 82 by vibrating at high frequency.

The counterbalance 85 is connected to axial direction oscillator 83 on the side opposite to that facing the vibration body 82. A second fixing flange 88 is formed at a suitable location on the side surface of the counterbalance 85, and the counterbalance 85 is fixed to the casing 86 via the second fixing flange 88. Although it is possible to make the second fixing flange, for example, into a circular plate shaped fixing member, it is also possible to make it into a fixing member that has a plurality of openings, or can be made, for example into a fixing member that has thin and long supporting members that extend in three directions, and when it has openings, etc., even if the second fixing flange 88 is fixed to the casing 86, it is possible to obtain sufficient air passage between the inside and outside of the casing 86. In addition, the counterbalance 85 vibrates due to the axial direction oscillator 83, and goes into the resonant state in which a standing wave is formed locally in the Z direction. Here, the position of the second fixing flange 88 has become a node for the axial vibrations for the counterbalance 85, and by fixing it via the second fixing flange 88, it is possible to prevent the axial vibrations of the vibration body 82 from being obstructed. In addition, even the counterbalance 85 is formed of the same material as the vibration body 82.

The casing 86 is a member being, for example, a square pole shaped and having an internal space for containing the vibration body 82 and the counterbalance 85, etc., and supports and fixes the vibration body 82 and the counterbalance 85 on its inside via the first and second fixing flanges 87 and 88. At one end of the casing 86 the above first fixing flange 87 that covers fully or partially the opening is provided, and at the other end an air supply pipe 92 that is coupled to the opening on the end surface is provided. This air supply pipe 92 is connected to a gas supplying apparatus (described later), and compressed dry air is supplied to the interior of the casing 86 with the desired flow rate and temperature of the air having been set.

In the above vibration cutting unit 20, the vibration body 82, axial direction oscillator 83, and the counterbalance 85 are mutually coupled and fixed by brazing, and efficient vibrations of the axial direction oscillator 83 is made possible. On center of axle of each of the vibration body 82, axial direction oscillator 83, and counterbalance 85, there is formed through hole 91 that passes through them in a way to traverse their joint surfaces, and pressurized dry air coming from air-supply pipe 92 runs through the through hole. In other words, the through hole 91 is a supply path to send out pressurized dry air, and it constitutes a cooling device for cooling vibration cutting unit 20 from its inside, together with an unillustrated gas supply device and air supply pipe 92. A tip portion of the through hole 91 is also used as a holding hole into which cutting tool 23 is inserted to be fixed, and pressurized dry air introduced to the through hole 91 can be supplied to the periphery of the cutting tool 23. Further, a tip of the through hole 91 still has a gap even when the cutting tool 23 is fixed, and therefore, pressurized dry air is jetted at high speed from opening 91a that is formed to be adjacent to the cutting tool 23, whereby, a working point at the tip of the cutting tool 23 can be cooled efficiently, and chips adhering to the working point and its periphery can be removed surely by an air current.

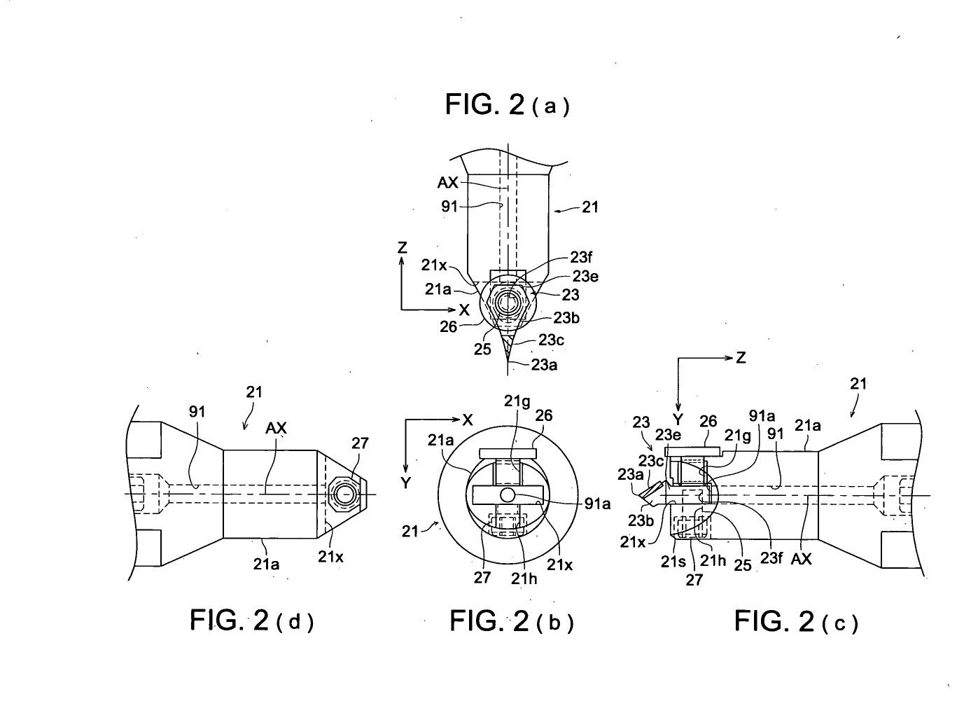

FIG. 2(a) is the plan view diagram of the tip of the tool part 21 shown in FIG. 1, and FIG. 2(b) is the front view diagram of the tip of the tool part 21, and FIG. 2(c) is the side view diagram of the tip of the tool part 21, and further FIG. 2(d) is the bottom surface view diagram of the tip of the tool part 21.

As is apparent from FIGS. 2(a)-2(d), tip portion 21a provided on tool portion 21 has tapered form that is a wedge form on a top view. The cutting tool 23 held on tip portion 21a is equipped with plate-shaped shank 23b whose tip is triangle and whose base side is hexagon, and with triangle working tip 23c fixed in a inclined stated on a tip portion of the shank 23b, that is tip 23a. Among them, shank 23b is a supporting member formed by cemented carbide, ceramics material or high-speed steel (high-speed tool steel) or others, and it is hardly bent. Further, the working tip 23c is a tip made of diamond which is fixed on the tip portion of shank 23b through brazing. The cutting tool 23 itself is embedded into tip portion 21a to be fixed, and the tip 23a of the working tip 23c is arranged on an extension of tool axis AX.

The fixing part 23e of the cutting tool 23, that is, of the shank 23b has been inserted in the groove 21x formed flat along the XZ plane that includes the tool axis AX in the tip part 21a. The side surface of groove 21x along the XZ plane is rectangular. The fixing part 23e supported by this groove 21x has been fixed firmly to the tip part 21a in a removable manner by a fixing screw 25 and a nut 27. The fixing screw 25 is a bolt (the second fixing member) of the shape of a flat-headed screw, and this is passed from one end side of the fixing hole 21g, and is screwed into the nut 27 fixed at the other end of the fixing hole 21g. Here, the fixing screw 25 and the nut 27 together function as the fixing devices for fixing the cutting tool 23 to the tip of the tool part 21. In other words, the fixing screw 25 is the second fixing member, and the nut 27 is the first fixing member. On the upper part of the fixing screw 25 a filling screw 26 is screwed in and fixed to fill the fixing hole 21g for passing the fixing screw 25. In addition, the fixing holes 21h and 21g extend in the direction of the Y axis, and the direction of fixing the fixing screw 25 and the nut 27 is at right angles to the tool axis AX.

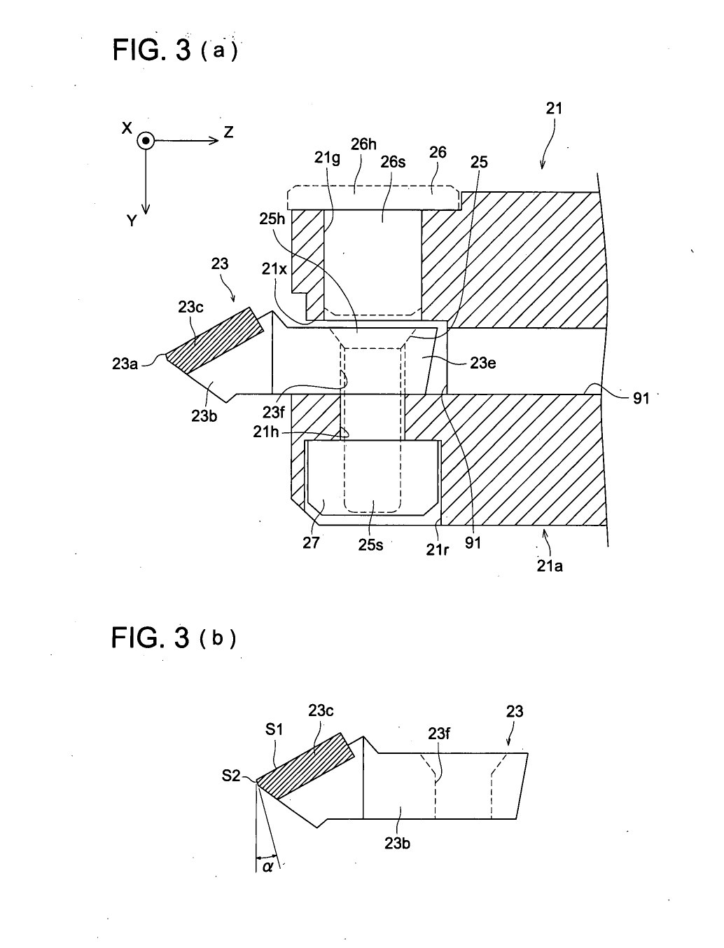

FIG. 3(a) is a partially enlarged cross-sectional view diagram for describing the condition of the tip part 21a of the tool part 21, and FIG. 3(b) is an enlarged side view diagram of the cutting tool 23.

The tip part 21a of the tool part 21 is the supporting portion for mounting the cutting tool 23, and it is not only possible to fix the cutting tool 23 in a removable manner but also the current cutting tool 23 can be replaced with another cutting tool of the same type or of a different type. The nut 27, among the fixing screw 25 and the nut 27 for mounting the cutting tool 23 in a removable manner, is placed so that it gets embedded inside the recessed part 21r formed on the bottom surface of the tip part 21a, and the top surface of the nut 27 has been fixed by brazing to the bottom part (top surface) of the recessed part 21r. The body part 25s of the fixing screw 25 can be screwed into the nut 27 and can be tightened. At the time of assembling the tool part 21, at first, the fixing part 23e of the shank 23b is inserted into the groove 21x of the tip part 21a. Next, via the fixing hole 21g provided in the upper part of the tip part 21a, the body part 25s of the fixing screw 25 is inserted into the hole 23f of the shank 23b and the fixing hole 21h provided on the lower side, and the tip of that body part 25s is screwed into the nut 27 fixed to the bottom end of the fixing hole 21h. Here, the internal diameter of the fixing hole 21g is larger than the internal diameter of the fixing hole 21h for passing the head part 25h of the fixing screw 25. At this time, since the fixing part 23e of the cutting tool 23 gets tightened between the head part 25h of the fixing screw 25 and the inner surface of the groove 21x, not only that separation of the cutting tool 23 is prevented and firm fixing of the cutting tool 23 to the tip part 21a is achieved, but also, the bottom surface of the fixing part 23e and the bottom surface of the groove 21x come into close contact with each other and it is possible to transmit the vibration energy with a low loss. Next, filling screw 26 is screwed and fixed into the fixing hole 21g provided on the upper part of the tip part 21a. A very small gap is formed between the bottom end surface of the filling screw 26 screwed into in this manner and the top end surface of the head part 25h of the fixing screw 25, thereby avoiding contact between the fixing screw 25 and the filling screw 26. The filling screw 26 has the effect of balancing the weight in the Y direction, in the neighborhood of the groove 21x of the tip part 21a, that is, the tool mounting section symmetrically with respect to the tool axis AX, and it is possible to prevent unnecessary vibrations from being generated in the tip part 21a and stable fundamental vibrations can be realized.

Further, it is also possible to have a structure in which no gap is provided between the bottom end surface of the filling screw 26 and the top end surface of the fixing screw 25. In this case, since the fixing screw is tightened from the top due to surface contact and any loosening of the fixing screw 25 is prevented, the fixing of the cutting tool 23 becomes more firm, and it is possible to reduce unnecessary vibrations or loosening of the cutting tool 23. In addition, when the fixing screw 25 is tightened by the filling screw 26, the stress upon the fixing screw 25 gets reduced, and breakage of the fixing screw 25, etc. can be prevented more effectively.

It is desirable that the tensile strengths of the fixing screw 25 and the nut 27 for fixing the cutting tool 23 to the tip part 21a of the vibration body 82 are different from each other. Because of this, since it is possible to enhance the tightening strength and durability against repeated use of the fixing member having the higher tensile strength among the fixing screw 25 and the nut 27, the life of the vibration cutting unit 20 can be extended by replacing the other fixing member. In addition, since the nut 27 has been fixed by brazing, vibrations generated by the nut 27 can be directly prevented, and since the fixing screw 25 can be tighten sufficiently to the nut 27, even if the vibration body 82, that is, the cutting tool 23 is vibrated at a high speed, the generation of friction heat that cannot be ignored between the bottom surface of the groove 21x and the bottom surface of the fixing part 23e can be prevented.

In the present preferred embodiment, in particular, the tensile strength of the nut 27 is larger than the tensile strength of the fixing screw 25. This is based on the consideration of the fact that, since the nut 27 has been fixed to the bottom end of the fixing hole 21h provided in the tip part 21a, that is, to the bottom surface of the recessed part 21r, if the nut 27 breaks, it will be necessary to replace the vibration body 82 that includes the tip part 21a. In other words, when the attaching and detaching of the cutting tool 23 is repeated, although the fixing screw 25 having the smaller tensile strength gets deteriorated, it is sufficient to replace only the fixing screw 25, breakage of the nut 27 can be prevented, and the frequency of replacement of the vibration body 82 can be reduced.

As the material of the nut 27, high-speed steel, cemented carbide, martensitic stainless steel, precipitation hardened stainless steel, SCM steel (chrome molybdenum steel), etc. can be used. These materials, high-speed steel, cemented carbide, martensitic stainless steel, precipitation hardened stainless steel, SCM steel (chrome molybdenum steel), etc., are materials that can make the tensile strength larger than the fixing screw 25. The concrete tensile strength of the nut 27 is, for example, about 900 N/mm² to 3000 N/mm² by using the above materials. The tensile strength of high-speed steel is 2650 N/mm², the tensile strength of cemented carbide is 1960 N/mm², and the tensile strength of SCM435 is 930 N/mm². When the nut 27 is formed of high-speed steel, the tensile strength becomes large and it becomes easier to tighten strongly the cutting tool 23. Further, when the nut 27 is formed of cemented carbide, since the nut 27 becomes heavier relative to high-speed steel or SCM steel, the balancing by the filling screw 26 becomes important.

As a material for the fixing screw 25, various types of metals can be used including various types of stainless steel or alloys such as SCM steel, etc. can be used. Stainless steel and SCM steel are superior in workability, and are materials that can make the tensile strength smaller compared to the nut 27. The concrete tensile strength of the fixing screw 25 is in the range of about 700 N/mm² to 1900 N/mm² by using the above materials. Although the fixing screw 25 can be reused, it should be replaced after cutting tool 23 has been repeatedly attached to the vibration body 82 a specific number of times.

Returning to FIG. 2, considering the internal dimensions of the groove 21x into which the fixing part 23e of the cutting tool 23 is inserted, the width in the Y axis direction is slightly larger than the external dimension of the fixing part 23e of the cutting tool 23. In addition, at the center of the bottom surface of this groove 21x, an opening 91a has been formed for ejecting the compressed dry air fed from the through hole 91 towards the tip part 21a of the tool part 21. Because of this, it is possible to cool the top surface of the cutting tool 23 directly and without waste from the side of the fixing part 23e that is supported being engaged into the tip part 21a. Further, since compressed dry air is emitted towards the tip of the cutting tool 23 from the opening 91a that is near the machining point on the work, it is possible to suppress the rise in temperature of the work, and to increase the machining accuracy. Also, any cutting dust that gets adhered to the machining point or its neighborhood of the work can be quickly removed.

In the vibration cutting unit 20 according to the present preferred embodiment, as has already been described, the material of the vibration body 82 is formed of a low linear expansion coefficient material such as Inver, Inver, super-Inver, stainless Inver, etc.

The Invar material is an alloy containing Fe and Ni, and it is an iron alloy containing Ni of 36 atomic percent whose coefficient of linear expansion at a room temperature is normally 1×10⁻⁶ or less. Its Young's modulus is as low as about a half of that of steel, and when this is used as a material of the vibration body 82, thermal expansion and contraction of the vibration body 82 are restricted, and temperature drift for the position of a cutting edge of cutting tool 23 held on the tip can be restricted.

Further, the super Invar material is an alloy containing at least Fe, Ni and Co, and it is an iron alloy containing Ni of 5 atomic percent or more and Co of 5 atomic percent or more, and its coefficient of linear expansion is normally about 0.4×10⁻⁶ at a room temperature, which means that the super Invar material is more resistant for thermal expansion and thermal contraction than the aforesaid Invar material. Its Young's modulus is as low as about a half of that of steel, and when this is used as a material of the vibration body 82, thermal expansion and thermal contraction of the vibration body 82 are restricted, and temperature drift for the position of a cutting edge of cutting tool 23 held on the tip can be restricted.

The stainless Invar material means all alloy materials wherein a main component with 50 atomic percent or more is Fe, and an incident material containing 5 atomic percent or more is at least one of Co, Cr and Ni. Therefore, in this case, Kovar material is also included in this stainless Invar material. The coefficient of linear expansion of the stainless Invar material is normally 1.3×10⁻⁶ or less at a room temperature. Young's modulus of the stainless Invar material is as low as about a half of that of steel, and when this is used as a material of the vibration body 82, thermal expansion and contraction of the vibration body 82 are restricted, and temperature drift for the position of a cutting edge of cutting tool 23 held on the tip can be restricted. Further, the stainless Invar material is suitable as a material of the structure to hold and fix the cutting tool 23, because it has an excellent characteristic of being much higher than the Invar material in terms of resistance to moisture, and it does not gather rust even when it is exposed to a cooling liquid for processing.

### Second Embodiment

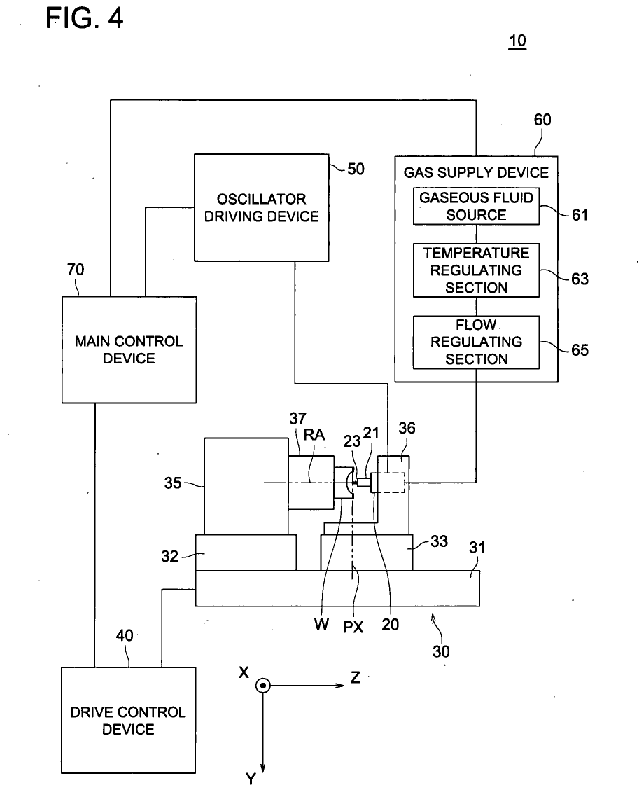

A processing apparatus relating to the second embodiment of the invention will be described as follows, referring to the drawings. FIG. 4 is a block diagram illustrating conceptually the structure of a processing apparatus of a vibration cutting type that processes a transfer optical surface of a molding die which molds an optical element such as a lens.

As shown in FIG. 4, processing apparatus 10 is equipped with vibration cutting unit 20 for cutting work W representing an object to be processed, NC drive mechanism 30 that supports the vibration cutting unit 20 for the work W, drive control device 40 that controls operations of the NC drive mechanism 30, oscillator driving device 50 that gives desired vibrations to the vibration cutting unit 20, gas supply device 60 that supplies gas for cooling to the vibration cutting unit 20 and main control device 70 that controls operations of the total apparatus on a general control basis.

The vibration cutting unit 20 is a vibration cutting tool wherein cutting tool 23 is embedded in the tip of tool portion 21 extending in the Z direction, and high frequency vibrations of this cutting tool 23 cut the work W efficiently. The vibration cutting unit 20 has the structure described in the first embodiment.

The NC drive mechanism 30 is a driving device having the structure wherein first stage 32 and second stage 33 are placed on pedestal 31. The first stage 32 supports first movable portion 35 which supports the work W indirectly through chuck 37. The first stage 32 can move the work W to the desired position at desired speed in, for example, the Z direction. Further, the first movable portion 35 can rotates the work W around horizontal axis of rotation RA at the desired speed. On the other hand, the second stage 33 supports second movable portion 36 which supports the vibration cutting unit 20. The second stage 33 can support the second movable portion 36 and the vibration cutting unit 20, and can move these to the desired positions along X axis direction or Y axis direction, at the desired speed. Further, the second movable portion 36 can rotate the vibration cutting unit 20 around vertical pivot axis PX that is in parallel with Y axis by a desired amount of angle at the desired speed. In particular, it is possible to rotate the vibration cutting unit 20 around its tip point by a desired angle by arranging the tip point of the vibration cutting unit 20 on the vertical pivot axis PX after adjusting properly a fixing position and angle of the vibration cutting unit 20 for the second movable portion 36.

Incidentally, in the aforesaid NC drive mechanism 30, the first stage 32 and the first movable portion 35 constitute a work driving portion that drives the work W, while, the second stage 33 and the second movable portion 36 constitute a tool driving portion that drives the vibration cutting unit 20.

The drive control device 40 is one to make highly accurate numerical control possible, and it operates properly the first stage 32, the second stage 33, the first movable portion 35 and the second movable portion 36 to the aimed states, by driving a motor and a position sensor housed in NC drive mechanism 30 under the control of the main control device 70. For example, while moving (feeding operation), at a low speed, a processing point of the tip of cutting tool 23 provided on a tip of tool portion 21 of vibration cutting unit 20, relatively for work W, along the prescribed locus established in a plane parallel to XZ plane, by the first stage 32 and the second stage 33, it is possible to rotate the work W at high speed around horizontal axis of rotation RA by the first movable portion 35. As a result, NC drive mechanism 30 can be utilized as a highly precise lathe under the control by drive control device 40. In this case, the tip of cutting tool 23 can be rotated properly around vertical pivot axis PX, with a processing point corresponding to the tip of cutting tool 23 serving as a center by the second movable portion 36, thus, the tip of cutting tool 23 can be set to the desired posture (inclination) for the point of work W to be processed.

Oscillator drive device 50 is one to supply electric power to a vibration source built in vibration cutting unit 20, and it can vibrate the tip of tool portion 21 at desired frequency and desired amplitude under the control of main control device 70, with a built-in oscillation circuit and a PLL circuit. Incidentally, as the details will be described later, a tip of the tool portion 21 is capable of conducting a bending vibration in the direction perpendicular to the axis (namely, tool axis AX extending in the direction of a depth of cut), and a vibration in the axial direction, and its two-dimensional vibration and three-dimensional vibration make it possible to conduct minute and efficient processing in which the tip of the tool portion 21, that is, the cutting tool 23 faces a surface of the work W.

Gas supply device 60 is one to cool the vibration cutting unit 20, and it is equipped with gaseous fluid source 61 that supplies pressurized dry air, temperature adjusting portion 63 serving as a temperature adjusting device that allows the passage of pressurized dry air coming from the gaseous fluid source 61 to adjust its temperature and flow rate adjusting portion 65 serving as a flow rate adjusting device that adjusts the flow rate of pressurized dry air having passed through the temperature adjusting portion 63. In this case, the gaseous fluid source 61 feeds air into a drying machine employing, for example, a thermal process or a dessicator to dry the air, and pressure of the dried air is enhanced by a compressor to the desired pressure. Further, temperature adjusting portion 63 that is not illustrated has, for example, flow channels for circulating coolants to peripheries and temperature sensors provided on the half way of the flow channels, and it can adjust pressurized dry air that has passed through the flow channel to the desired temperature by adjusting temperature and an amount of supply of the coolant. In addition, the flow rate adjusting portion 65 has, for example, a valve or a flow controller (not shown), and it can adjust a flow rate in the case of supplying the temperature-adjusted pressurized dry air to vibration cutting unit 20.

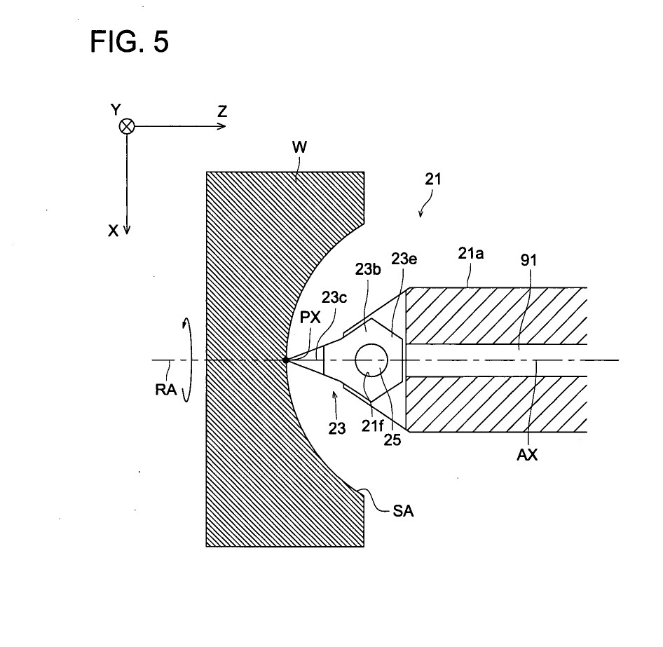

FIG. 5 is an enlarged top view for illustrating how work W is processed by processing apparatus 10 shown in FIG. 4. Tip portion 21a of tool portion 21 vibrates at high speed on YZ plane, for example, as described already. Further, the Tip portion 21a of tool portion 21 is moved gradually on XZ plane for work W representing an object to be processed by NC drive mechanism 30 shown in FIG. 4, while drawing the prescribed locus. That is, feeding operations for the tool portion 21 are conducted. Further, the work W representing an object to be processed is rotated at the constant speed around rotation axis RA that is in parallel with Z axis, by NC drive mechanism 30 shown in FIG. 4 (see FIG. 4). Owing to this, lathing processing for work W is made possible, and it is possible to form, for example, surface to be processed SA (for example, stepped surface such as phase element surface in addition to curved surface such as concavoconvex spherical surface and aspheric surface) that is rotation-symmetrical around rotation axis RA for the work W. In this case, vibration surface (elliptic orbit EO) of the tip of cutting tool 23 is made to be perpendicular substantially to the surface to be processed SA which is to be formed on the work W, by rotating the tip of cutting tool 23 of tool portion 21 around pivot axis PX that is in parallel with Y axis direction by the use of second stage 33. Owing to this, a processing point on the cutting edge of the tool can be maintained at one point substantially during processing, whereby, efficient transmission of vibration to the processing point and highly accurate vibration cutting that depends on no cutting edge form can be realized, thus, processing accuracy for surface SA to be processed can be enhanced, and surface SA to be processed can be made to be more smooth. Further, since pressurized dry air is jetted at high speed toward the tip of cutting tool 23 from opening 91a on the tip of tool portion 21 in the course of processing of work W, it is possible not only to cool cutting tool 23 and surface SA to be processed efficiently but also to make temperatures of cutting tool 23 and of surface SA to be processed to be within a certain range by temperature and flow rate of pressurized dry air. Since this pressurized dry air is introduced via through hole 91 that passes through a center of axle of tool portion 21, to flow through insides of vibration body 82, axial direction oscillator 83 and counterbalance 85, temperatures of vibration body 82 and others can be adjusted by temperature and flow rate of the pressurized dry air. Temperatures of the vibration body 82 can be stabilized by adjusting the temperature of the pressurized dry air as stated above, resulting in reduction of temperature drift of the tip position of cutting tool 23 held on the tip, and a surface subjected to cutting work having high accuracy and high reproducibility can be obtained.

### Third Embodiment

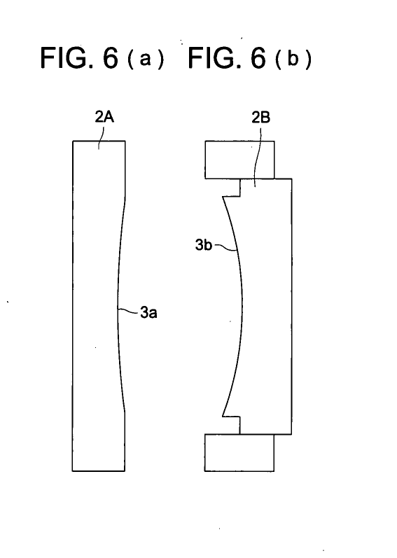

A molding die relating to the third embodiment of the invention will be described as follows. FIG. 6 is a diagram illustrating an molding die (molding die for optical element) prepared by using vibration cutting unit 20 in the first embodiment, in which FIG. 6(a) is a side sectional view of a fixed mold that is first mold 2A, and FIG. 6(b) is a side sectional view of a movable mold that is second mold 2B. Transfer optical surfaces 3a and 3b respectively of both molds 2A and 2B are those subjected to finishing processing conducted by processing apparatuses 10 shown in FIG. 4 or others. In other words, a material (material is, for example, cemented carbide) for each of both molds 2A and 2B is fixed on chuck 37 as work W, and oscillator driving device 50 is operated to vibrate cutting tool 23 at high speed while forming standing waves on vibration cutting unit 20. Simultaneously with this, drive control device 40 is operated appropriately to move optionally the tip of tool portion 21 of vibration cutting unit 20 for work W on a three-dimensional basis. Due to this, transfer optical surfaces 3a and 3b respectively of both molds 2A and 2B can be made to be a stepped surface, a phase structure surface and a diffractive structure surface without being limited to a spherical surface and an aspheric surface.

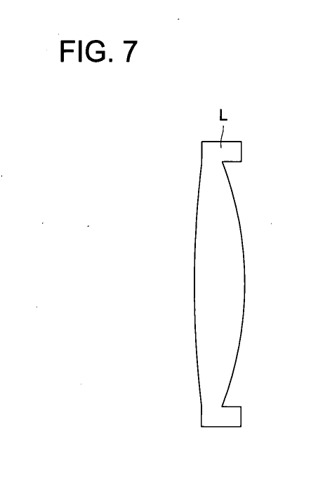

FIG. 7 is a sectional view of lens L press-molded by the use of mold 2A shown in FIG. 6(a) and mold 2B shown in FIG. 6(b). When transfer optical surfaces 3a and 3b respectively of molds 2A and 2B have a stepped surface, a phase structure surface and a diffractive structure surface, the formed optical surfaces of lens L also have a stepped surface, a phase structure surface and a diffractive structure surface though not illustrated. Further, a material of lens L can be glass without being limited to plastic. Incidentally, an optical element such as lens can also be made directly by processing apparatus 10 in the second embodiment.

### Fourth Embodiment

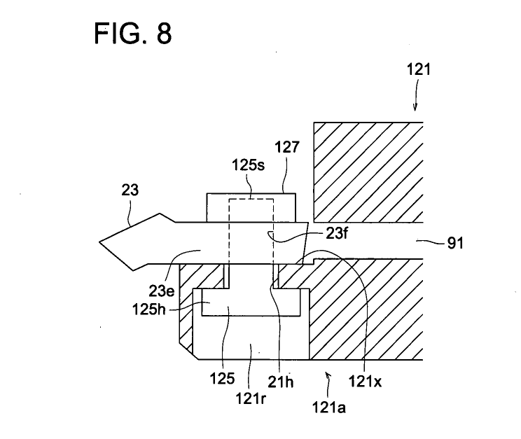

FIG. 8 is a cross-sectional view diagram showing the structure of the vibration cutting unit of the fourth preferred embodiment of the present invention. The vibration cutting unit according to the fourth preferred embodiment is one in which the vibration cutting unit shown in FIG. 3, etc., has been modified.

Although the tool part 121 of the vibration cutting unit, at the tip part 121a, supports the cutting tool 23 by means of the fixing screw 125 and nut 127. In this case, the fixing screw 125 is fixed as the first fixing member to the tip part 121a, and the nut 127 is fixed as the second fixing member by getting screwed on to the fixing screw 125. Between the fixing screw 125 and the nut 127, the fixing screw 125 is arranged so that its head part 125h gets embedded into the recessed part 121r formed in the bottom surface of the tip part 121a, and the fixing screw 125 is fixed by brazing on the inner circumferential surface of the fixing hole 21h, to the bottom surface (top surface) of the recessed part 121r opposed by the top surface and side surface of the head 125h. The nut 127 can be screwed on to the body part 125s of the fixing screw 125. At this time, since the fixing part 123e of the cutting tool 123 gets tightened by being gripped between the nut 127 and the flat supporting surface 121x at the top of the tip part 121a, separation of the cutting tool 23 is prevented and firm fixing of the cutting tool 123 to the tip part 121a is obtained.

In this case, in particular, the tensile strength of the fixing screw 125 is larger than the tensile strength of the nut 127. This is based on the consideration of the fact that, since the fixing screw 125 has been fixed to the bottom surface of the recessed part 121r provided in the tip part 121a, if the fixing screw 125 breaks, it will be necessary to replace the tip part 121a.

### MACHINING IMPLEMENTATION EXAMPLE 1

In the following, an example of implementing machining using the vibration cutting unit 20 of the preferred embodiment is described. In order to prevent the position of the tool tip from changing substantially due to heat generation and changes of the ambient temperature, stainless Inver material was used for the vibration body 82. As has been described earlier, the tensile strength of Inver is small, when the cutting tool 23 is attached and detached repeatedly using a conventional fixing tool, the thread portion of the fixing tool gets deformed immediately, and it is not possible to fix the cutting tool firmly. Therefore, the cutting tool 23 was fixed using a fixing screw 25 and nut 27 according to the preferred embodiment described earlier. In concrete terms, SCM430 (tensile strength of 900 N/mm²) was used as the material for the nut 27, and SUS420J2 (tensile strength of 780 N/mm²) was used as the material for the fixing screw 25. Using this, the cutting tool 23 was fixed firmly to the vibration body 82, and actual vibration cutting was carried out.

For the vibration cutting, an ultra-high precision lathe equivalent to the processing apparatus 10 shown in FIG. 4 was used. As is shown in FIG. 4, on a level block equivalent to a base 31, a first stage 32 that includes a Z axis stage driven in the direction of Z axis, and a second stage 33 that includes an X axis stage driven in the direction of X axis have been mounted. On top of the first stage 32, a first movable part 35 that includes the main shaft for rotating the work W was mounted, and on top of the second stage 33, a second movable part 36 that includes the turning shaft for adjusting the orientation of the cutting tool 23 was mounted.

Micro Alloy F (Hardness HV1850) manufactured by Tungaloy Corporation was used as a material of work W. In this embodiment, the machining profile to be formed on work W was a flat surface to simply judge whether correct vibration cutting was carried out.

A diamond processing tip 23c of cutting tool 23 used for cutting is an R cutting tool wherein opening angle θ of cutting face S1 is 60° and its tip portion is formed to be in a circular arc form. A radius of a circular arc on the tip of a cutting face S1 of a cutting edge is 0.8 mm, angle of relief α at the tip of cutting face S1 is 10°, an angle of the cutting face S1 at the cutting point is −25°, and an amount of cutting by processing tip 23c in this case is 3 μm. In the vibration cutting by using this vibration cutting unit 20, vibration in the axial direction and vibration in the bending direction were conducted, and the cutting edge locus corresponds to circular motion or elliptic motion. As a result, it was possible to make an amount of cutting to be several times as large as that in ordinary processing which is not vibration cutting even in the case of ductility mode cutting, because it is possible to cut in a way to scoop up with a cutting face.

When the surface roughness was measured on the machined surface obtained by vibration cutting of the present embodiment, with surface roughness measuring instrument HD3300 made by WYKO Co., an average surface roughness of Ra 3.6 nm as a preferable optical mirror surface was obtained. When the above processed surface was observed under a microscope, chatter marks showing fine abnormal vibration of cutting tool 23 were not observed on the machined surface.

### MACHINING IMPLEMENTATION EXAMPLE 2

Similar to the machining implementation example 1, stainless Inver was used as the material for the vibration body 82. High-speed steel having an extremely high tensile strength (tensile strength of 2600 N/mm²) was used as the material for the nut 27, and SCM435 (tensile strength of 930 N/mm²) was used as the material for the fixing screw 25. Using this, the cutting tool 23 was fixed firmly to the vibration body 82, and actual vibration cutting was carried out.

For the vibration cutting, an ultra-high precision lathe equivalent to the processing apparatus 10 shown in FIG. 4 was used, similar to the case of the machining implementation example 1.

Micro Alloy F (Hardness HV1850) manufactured by Tungaloy Corporation was used as a material of work W. The machining profile to be formed on work W was an aspheric optical surface form. A form of an aspheric optical surface to be processed is a small and deep concave optical surface whose approximation R is about 0.9 mm, a central radius of curvature is 1.33 mm and a maximum estimated angle is 65°. A surface to become an optical surface of the work W is processed to be a concave spherical surface through an electron discharge method in advance, and further, a versatile high-precision grinding machine whose axial resolution power is about 100 nm was used to conduct crude processing for changing from an approximate spherical surface form to an aspheric surface form. In this crude grinding processing, an electrodeposition grindstone was used to repeat form correction to finish to the aspheric surface form by grinding to the level of about 1 μm in terms of form accuracy in a short period of time.

A diamond processing tip 23c of cutting tool 23 used for finish cutting is an R cutting tool wherein opening angle θ of cutting face S1 is 30° and its tip portion is formed to be in a circular arc form. A radius of a circular arc on the tip of a cutting face of a cutting edge is 0.8 mm, angle of relief a at the tip of cutting face S1 is 5°, an angle of the cutting face S1 at the cutting point is −25°, and an amount of cutting by processing tip 23c in this case is 2 μm. In this case, the cutting processing was conducted under the condition that a rotation rate of a main spindle of the first movable portion 35 on which work W was clamped was 340 rpm and feed rate was 0.2 mm/min. Further, pivot axis of the second stage 33 on which vibration cutting unit 20 was fixed was controlled, and a form creating processing was carried out in a way that the axial vibration direction of cutting tool 23 and a normal line direction of a design optical surface representing a target processed form may agree with each other.

When the processed surface obtained by vibration cutting of the present embodiment was observed under a microscope, a regular cutting mark considered to be a vibration cycle of vibration cutting was observed in the same way, but scratches observed in the case of use of conventional vibration devices were not observed. When the surface roughness was measured by surface roughness measuring instrument HD3300 made by WYKO Co., average surface roughness was Ra 3.1 nm and a preferable optical mirror surface was obtained. A form error (form precision) on the processed surface was improved to 0.05 μmPV by conducting one form correcting processing. When an optical surface was subjected to cutting processing for another work W″ by using cutting tool 23 which had been used for the previous work W and a newly prepared NC program for correction of the form processed on the previous work W, surface roughness and form precision which are substantially the same as those for the previous work W were obtained, and excellent processing reproducibility was confirmed.

Although the present invention has been described above using some preferred embodiments, the present invention shall not be construed to be restricted to the above preferred embodiments. For example, the materials of the fixing screw 25 and the nut 27 need not be restricted to high-speed steel, cemented carbide, martensitic stainless steel, precipitation hardened stainless steel, SCM steel, etc., and other steels can also be used, as long as the relationship of tensile strengths is satisfied.

Further, although in the above preferred embodiments, the nut 27, etc., was fixed by brazing to tip part 21a, it is also possible to fix the nut 27 to the tip part 21a by welding, etc.

Further, in the vibration cutting unit 20, it is possible to modify appropriately the shape of the tip part 21a or the method of mounting the cutting tool 23.

Further, in vibration cutting unit 20, overall shape or dimensions of vibration body 82 and axial direction oscillator 83 can be properly modified according to the use. When vibration cutting unit 20 is not heated much, supply of pressurized and dried air is not necessary, because dimension changes of the vibration body for cutting 82 do not need to be concerned about. Further, in gas supply device 60 shown in FIG. 4, it is possible to use gaseous fluid wherein oil and other lubricant elements other than air are added as misted solvents and particles as well as inert gas such as nitrogen gas.

Although cutting by a lathe has been described mainly in the aforesaid processing apparatus 10, vibration body for cutting shown in FIG. 1 and processing apparatus 10 shown in FIG. 4 can also be modified for ruling processing.

What is claimed is:

1. A vibration body for cutting, which transmits provided vibration to a cutting tool, the vibration body for cutting comprising:
a supporting portion for supporting the cutting tool;
a first fixing member fixed on the supporting portion; and
a second fixing member for fixing the cutting tool removably on the supporting portion, in cooperation with the first fixing member,
wherein the first fixing member has a greater tensile strength than a tensile strength of the second fixing member.

2. The vibration body for cutting of claim 1,
wherein the first fixing member is a nut and the second fixing member is a bolt screwed into the nut.

3. The vibration body for cutting of claim 2,
wherein the cutting tool is fixed while gripped between a supporting surface of the supporting portion and a head of the bolt by inserting the bolt into a hole for fixing provided on the cutting tool.

4. The vibration body for cutting of claim 2,
wherein the nut is adhered to the supporting portion.

5. The vibration body for cutting of claim 4,
wherein the nut is adhered to the supporting portion by means of brazing.

6. The vibration body for cutting of claim 1, formed of a material with a low linear expansion coefficient.

7. The vibration body for cutting of claim 1,
wherein the first fixing member is formed of at least one material selected from the group consisting of high-speed tool steel, cemented carbide, martensitic stainless steel, precipitation hardening stainless steel and SCM steel.

8. The vibration body for cutting of claim 1,
wherein a tensile strength of the first fixing member is 900 N/mm²-3000 N/mm² and a tensile strength of the second fixing member is 700 N/mm²-1900 N/mm².

9. The vibration body for cutting of claim 1,
wherein the first fixing member has a greater tensile strength than 1.2 times the tensile strength of the second fixing member.

10. The vibration body for cutting of claim 1,
wherein the first fixing member is a bolt and the second fixing member is a nut screwed into by the bolt.

11. A vibration cutting unit comprising:
the vibration body for cutting of claim 1; and
a vibration source for vibrating the cutting tool through the vibration body for cutting by providing vibration to the vibration body for cutting.

12. The vibration cutting unit of claim 11, further comprising:
the cutting tool supported by the vibration body for cutting.

13. A processing apparatus comprising:
the vibration cutting unit of claim 11;
a drive device for displacing the vibration cutting unit by driving the drive device.

14. A molding die comprising:
a transfer optical surface created by using the vibration cutting unit of claim 11, for forming an optical surface of an optical element.

15. An optical element created by using the vibration cutting unit of claim 11.
